(19) United States
(12) Patent Application Publication
(10) Pub. No.: US 2024/0185837 A1
(43) Pub. Date: Jun. 6, 2024

(54) INFORMATION PROCESSING APPARATUS, INFORMATION PROCESSING METHOD, AND PROGRAM

(71) Applicant: NIPPON TELEGRAPH AND TELEPHONE CORPORATION, Tokyo (JP)

(72) Inventors: Yoshiaki SHOJI, Musashino-shi, Tokyo (JP); Shiro OGASAWARA, Musashino-shi, Tokyo (JP); Tomoko SHIBATA, Musashino-shi, Tokyo (JP)

(73) Assignee: NIPPON TELEGRAPH AND TELEPHONE CORPORATION, Tokyo (JP)

(21) Appl. No.: 18/285,662

(22) PCT Filed: Apr. 6, 2021
(86) PCT No.: PCT/JP2021/014619

§ 371 Date: Oct. 5, 2023

(51) Int. Cl. G10L 15/04; G06V 30/148; G10L 15/02

(52) U.S. Cl. CPC G10L 15/04; G06V 30/153; G10L 15/02

(57) ABSTRACT

An information processing device of an embodiment includes a voice recognition unit, an image recognition unit, an extraction unit, a first correction unit, and a second correction unit. The voice recognition unit recognizes a plurality of first words on the basis of a first voice. The image recognition unit recognizes a plurality of second words on the basis of a first image. The extraction unit extracts at least one of a third word included in the plurality of first words and not included in the plurality of second words or a fourth word included in the plurality of second words and not included in the plurality of first words. The first correction unit corrects a fifth word corresponding to the third word among the plurality of second words to the third word. The second correction unit corrects a sixth word corresponding to the fourth word among the plurality of first words to the fourth word.

### TECHNICAL FIELD

An embodiment relates to an information processing device, an information processing method, and a program.

### BACKGROUND ART

A technology for utilizing logs accumulated by terminal operation is known. For example, pairing technology pairs an optimal respondent for an inquirer on the basis of the accumulated logs.

As a technology for accumulating logs, a voice recognition technology and an image recognition technology are known. The voice recognition technology extracts a word included in a voice as a log. The image recognition technology extracts a word included in an image as a log. With the voice recognition technology and the image recognition technology, words extracted from information in different formats can be handled in a common format.

For example, a method has been devised for improving accuracy of word recognition by processing simultaneously input voice and pen input.

### CITATION LIST

### Non Patent Literature

Non Patent Literature 1: Yasushi Watanabe and four others, “Study on Recognition Method for Simultaneous Input of Voice and Pen Input”, Institute of Electronics, Information and Communication Engineers Technical Report, Voice, Jun. 16, 2006, vol. 106, no. 123, p. 49-54

### SUMMARY OF INVENTION

### Technical Problem

However, in network communication such as an online meeting, in many cases, a voice and an image including a common word are not simultaneously input. Then, there are few methods for improving the accuracy of word recognition by combining a voice and an image that are not simultaneously input.

The present invention has been made in view of the above circumstances, and an object of the present invention is to provide a means for improving the accuracy of word recognition from a voice and an image.

### Solution to Problem

An information processing device of one aspect includes a voice recognition unit, an image recognition unit, an extraction unit, a first correction unit, and a second correction unit. The voice recognition unit recognizes a plurality of first words on the basis of a first voice. The image recognition unit recognizes a plurality of second words on the basis of a first image. The extraction unit extracts at least one of a third word included in the plurality of first words and not included in the plurality of second words or a fourth word included in the plurality of second words and not included in the plurality of first words. The first correction unit corrects a fifth word corresponding to the third word among the plurality of second words to the third word. The second correction unit corrects a sixth word corresponding to the fourth word among the plurality of first words to the fourth word.

### Advantageous Effects of Invention

According to an embodiment, it is possible to provide a means for improving the accuracy of word recognition from a voice and an image.

### BRIEF DESCRIPTION OF DRAWINGS

FIG. 1 is a block diagram illustrating an example of a configuration of an information processing system according to an embodiment.

FIG. 2 is a block diagram illustrating an example of a hardware configuration of an information processing device according to the embodiment.

FIG. 3 is a block diagram illustrating an example of a functional configuration of the information processing device according to the embodiment.

FIG. 4 is a flowchart illustrating an example of correction operation in the information processing device according to the embodiment.

FIG. 5 is a flowchart illustrating an example of correction operation for voice-based word information in the information processing device according to the embodiment.

FIG. 6 is a flowchart illustrating an example of correction operation for image-based word information in the information processing device according to the embodiment.

FIG. 7 is a diagram illustrating an application range of the correction operation in the information processing device according to the embodiment.

### DESCRIPTION OF EMBODIMENTS

Hereinafter, an embodiment will be described with reference to the drawings. Note that in the following description, components having the same function and configuration are denoted by the same reference numerals.

### 1. Embodiment

### 1.1 Configuration

### 1.1.1 Information Processing System

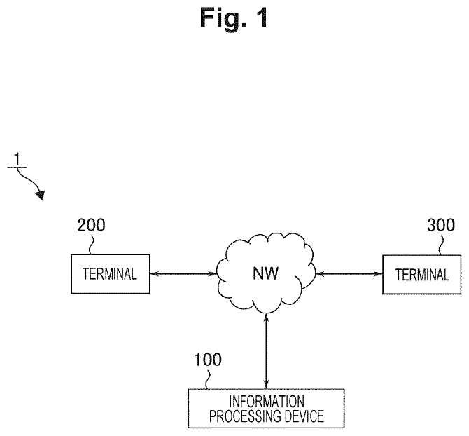

First, a configuration of an information processing system according to an embodiment will be described. FIG. 1 is a block diagram illustrating an example of the configuration of the information processing system according to the embodiment.

As illustrated in FIG. 1, an information processing system 1 is a computer network connected via a network NW. The network NW is a wide area network (WAN), a local area network (LAN), or the Internet. The information processing system 1 includes an information processing device 100 and terminals 200 and 300.

The information processing device 100 is, for example, a data server. The information processing device 100 stores media information shared between the terminal 200 and the terminal 300 via the network NW. The media information includes, for example, voice information and image information.

The terminals 200 and 300 are, for example, personal computers or smartphones. The terminals 200 and 300 share information via the network NW.

### 1.1.2 Information Processing Device

Next, an internal configuration of an information processing device according to the embodiment will be described.

### (Hardware Configuration)

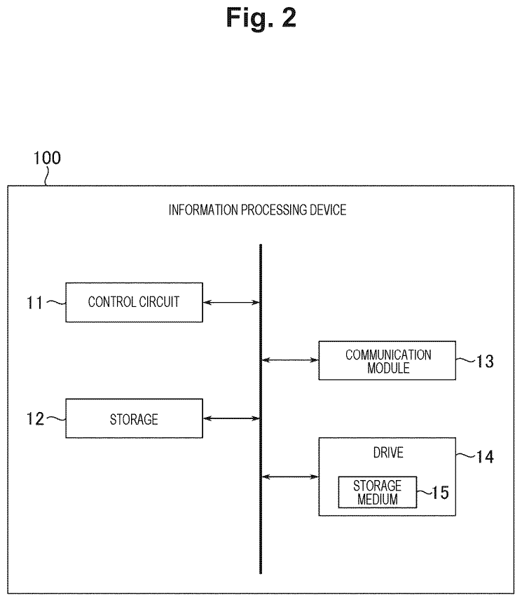

FIG. 2 is a block diagram illustrating an example of a hardware configuration of the information processing device according to the embodiment. As illustrated in FIG. 2, the information processing device 100 includes a control circuit 11, a storage 12, a communication module 13, and a drive 14.

The control circuit 11 is a circuit that entirely controls each component of the information processing device 100. The control circuit 11 includes a central processing unit (CPU), a random access memory (RAM), a read only memory (ROM), and the like.

The storage 12 is an auxiliary storage device of the information processing device 10. The storage 12 includes, for example, a hard disk drive (HDD), a solid state drive (SSD), a memory card, and the like. The storage 12 stores the media information received from the terminals 200 and 300. In addition, the storage 12 may store a program.

The communication module 13 is a circuit used for transmission and reception of the media information via the network NW. The communication module 13 transfers the media information received from the terminals 200 and 300 to the storage 12.

The drive 14 is a device for reading software stored in a storage medium 15. The drive 14 includes, for example, a compact disk (CD) drive, a digital versatile disk (DVD) drive, and the like.

The storage medium 15 is a medium that stores software by electrical, magnetic, optical, mechanical, or chemical action. The storage medium 15 may store a program.

### (Functional Configuration)

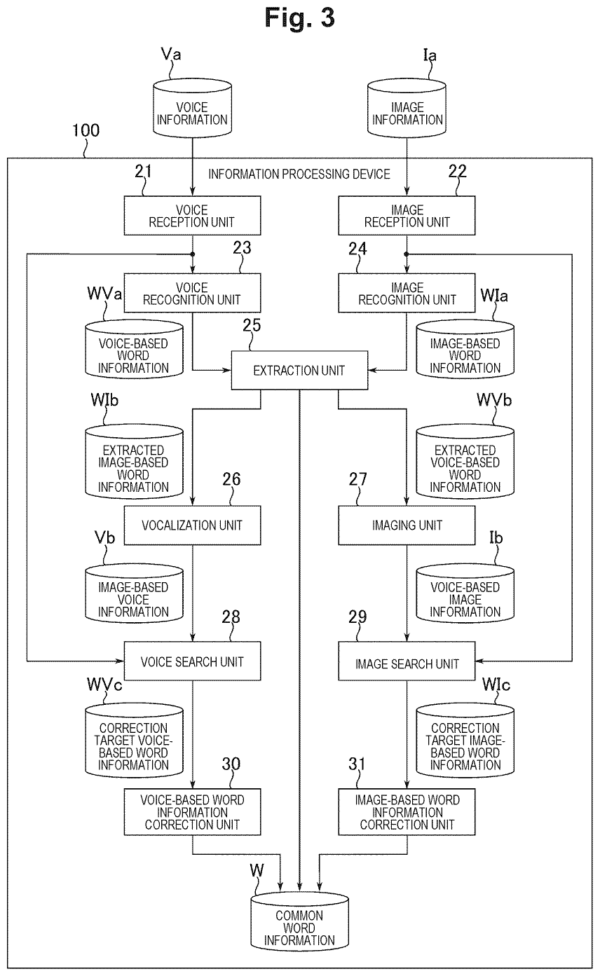

FIG. 3 is a block diagram illustrating an example of a functional configuration of the information processing device according to the embodiment.

The CPU of the control circuit 11 deploys a program stored in the storage 12 or the storage medium 15 in the RAM. Then, the CPU of the control circuit 11 interprets and executes the program deployed in the RAM. As a result, the information processing device 100 functions as a computer including a voice reception unit 21, an image reception unit 22, a voice recognition unit 23, an image recognition unit 24, an extraction unit 25, a vocalization unit 26, an imaging unit 27, a voice search unit 28, an image search unit 29, a voice-based word information correction unit 30, and an image-based word information correction unit 31.

The voice reception unit 21 receives voice information Va via the network NW. The voice reception unit 21 transmits the voice information Va to the voice recognition unit 23 and the voice search unit 28.

The voice information Va is media information including a voice. Even in a case where the voice means a plurality of words, the voice information Va does not include information for identifying the plurality of words.

The image reception unit 22 receives image information Ia via the network NW. The image reception unit 22 transmits the image information Ia to the image recognition unit 24 and the image search unit 29.

The image information Ia is media information including an image. Even in a case where the image means a plurality of words, the image information Ia does not include information for identifying the plurality of words.

The voice recognition unit 23 generates voice-based word information WVa on the basis of the voice information Va. Specifically, the voice recognition unit 23 converts the voice in the voice information Va into a character string by voice recognition processing. Various methods can be applied to the voice recognition processing, for example, acoustic analysis, an acoustic model, and the like. In addition, the voice recognition unit 23 classifies the character string into a plurality of words by morphological analysis. The voice recognition unit 23 transmits the plurality of words based on the voice information Va to the extraction unit 25 as the voice-based word information WVa. That is, the voice-based word information WVa identifies the plurality of words meant by the voice in the voice information Va.

The image recognition unit 24 generates image-based word information WIa on the basis of the image information Ia. Specifically, the image recognition unit 24 converts the image in the image information Ia into a character string by image recognition processing. Various methods can be applied to the image recognition processing, for example, optical character recognition (OCR), and the like. In addition, the image recognition unit 24 classifies the character string into a plurality of words by morphological analysis. The image recognition unit 24 transmits the plurality of words based on the image information Ia to the extraction unit 25 as the image-based word information WIa. That is, the image-based word information WIa identifies the plurality of words meant by the image in the image information Ia.

The extraction unit 25 generates extracted image-based word information WIb, extracted voice-based word information WVb, and common word information W on the basis of the voice-based word information WVa and the image-based word information WIa. Specifically, the extraction unit 25 extracts a word included in the image-based word information WIa and not included in the voice-based word information WVa, as the extracted image-based word information WIb. The extraction unit 25 transmits the extracted image-based word information WIb to the vocalization unit 26. In addition, the extraction unit 25 extracts a word included in the voice-based word information WVa and not included in the image-based word information WIa, as the extracted voice-based word information WVb. The extraction unit 25 transmits the extracted voice-based word information WVb to the imaging unit 27. In addition, the extraction unit 25 stores a word included in both the voice-based word information WVa and the image-based word information WIa in the storage 12 as the common word information W.

Note that the voice-based word information WVa and the image-based word information WIa are pieces of information independent of each other with respect to time. For this reason, extraction processing in the extraction unit 25 does not require simultaneous input of the voice-based word information WVa and the image-based word information WIa.

The vocalization unit 26 generates image-based voice information Vb on the basis of the extracted image-based word information WIb. Specifically, the vocalization unit 26 converts the word in the extracted image-based word information WIb into a voice. The vocalization unit 26 transmits the converted voice to the voice search unit 28 as the image-based voice information Vb.

The imaging unit 27 generates voice-based image information Ib on the basis of the extracted voice-based word information WVb. Specifically, the imaging unit 27 converts the word in the extracted voice-based word information WVb into an image. The imaging unit 27 transmits the converted image to the image search unit 29 as the voice-based image information Ib.

The voice search unit 28 searches the voice-based word information WVa for correction target voice-based word information WVc. Specifically, for example, the voice search unit 28 calculates a feature value of the voice in the image-based voice information Vb and a feature value of the voice in the voice information Va. The voice search unit 28 extracts, as a similar voice, a voice having a feature value whose similarity to the feature value of the voice in the image-based voice information Vb is greater than or equal to a threshold, from the voice information Va. Then, the voice search unit 28 extracts a word corresponding to the similar voice from the voice-based word information WVa. The voice search unit 28 transmits the word corresponding to the similar voice to the voice-based word information correction unit 30 as the correction target voice-based word information WVc.

The image search unit 29 searches the image-based word information WIa for correction target image-based word information WIc. Specifically, for example, the image search unit 29 calculates a feature value of the image in the voice-based image information Ib and a feature value of the image in the image information Ia. The image search unit 29 extracts, as a similar image, an image having a feature value whose similarity to the feature value of the image in the voice-based image information Ib is greater than or equal to a threshold value, from the image information Ia. Then, the image search unit 29 extracts a word corresponding to the similar image from the image-based word information WIa. The image search unit 29 transmits the word corresponding to the similar image to the image-based word information correction unit 31 as the correction target image-based word information WIc.

The voice-based word information correction unit 30 corrects the word in the correction target voice-based word information WVc on the basis of the extracted image-based word information WIb. The voice-based word information correction unit 30 stores the corrected word in the storage 12 as the common word information W.

The image-based word information correction unit 31 corrects the word in the correction target image-based word information WIc on the basis of the extracted voice-based word information WVb. The image-based word information correction unit 31 stores the corrected word in the storage 12 as the common word information W.

With the above configuration, the information processing device 100 can further include the word complementarily corrected by the voice information Va and the image information Ia in the common word information W.

### 1.2. Operation

Next, operation of the information processing device according to the embodiment will be described.

### 1.2.1 Outline of Correction Operation

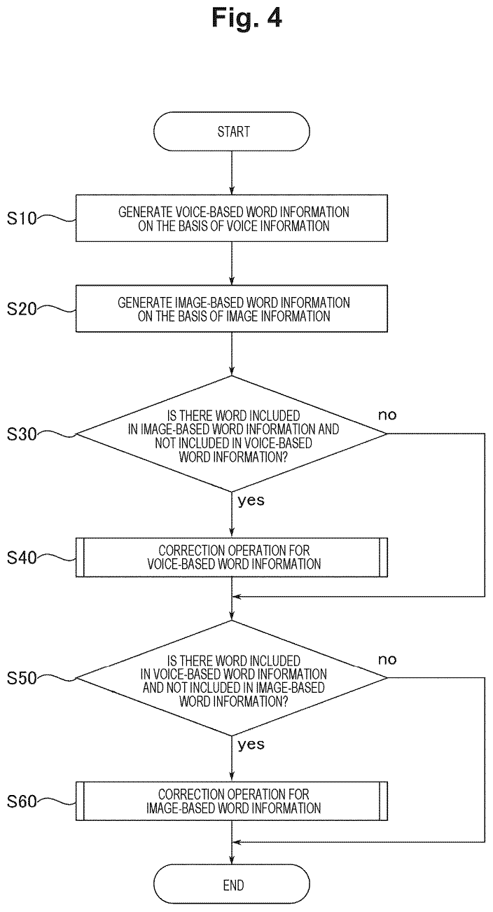

First, an outline of correction operation in the information processing device according to the embodiment will be described. FIG. 4 is a flowchart illustrating an example of the correction operation in the information processing device according to the embodiment. In the example of FIG. 4, a case is assumed where the voice information Va and the image information Ia are media information shared between the terminals 200 and 300 regarding a common agenda.

As illustrated in FIG. 4, when the voice information Va and the image information Ia are received (start), the voice recognition unit 23 generates the voice-based word information WVa on the basis of the voice information Va (S10).

The image recognition unit 24 generates the image-based word information WIa on the basis of the image information Ia (S20).

The extraction unit 25 determines whether or not there is a word included in the image-based word information WIa generated in the processing of S20 and not included in the voice-based word information WVa generated in the processing of S10 (S30).

In a case where there is no word included in the image-based word information WIa and not included in the voice-based word information WVa (S30; no), the processing proceeds to S50.

In a case where there is a word included in the image-based word information WIa and not included in the voice-based word information WVa (S30; yes), the extraction unit 25, the vocalization unit 26, the voice search unit 28, and the voice-based word information correction unit 30 execute the correction operation for the voice-based word information WVa (S40). As a result of the processing of S40, the corrected word is stored in the storage 12 as the common word information W. Details of the correction operation for the voice-based word information WVa will be described later.

The extraction unit 25 determines whether or not there is a word included in the voice-based word information WVa generated in the processing of S10 and not included in the image-based word information WIa generated in the processing of S20 (S50).

In a case where there is no word included in the voice-based word information WVa and not included in the image-based word information WIa (S50; no), the correction operation ends (end).

In a case where there is a word included in the voice-based word information WVa and not included in the image-based word information WIa (S50; yes), the extraction unit 25, the imaging unit 27, the image search unit 29, and the image-based word information correction unit 31 execute the correction operation for the image-based word information WIa (S60). As a result of the processing of S60, the corrected word is stored in the storage 12 as the common word information W. Details of the correction operation for the image-based word information WIa will be described later.

When the processing of S60 ends, the correction operation ends (end).

Note that, in the example of FIG. 4, a case has been described where the processing of S20 is executed after the processing of S10, but the present invention is not limited thereto. For example, the processing of S20 may be executed before the processing of S10. In addition, in the example of FIG. 4, a case has been described where the processing of S50 and S60 is executed after the processing of S30 and S40, but the present invention is not limited thereto. For example, the processing of S50 and S60 may be executed before the processing of S30 and S40.

### 1.2.2 Details of Correction Operation for Voice-Based Word Information

Next, a description will be given of details of the correction operation for the voice-based word information in the information processing device according to the embodiment.

### (Flowchart)

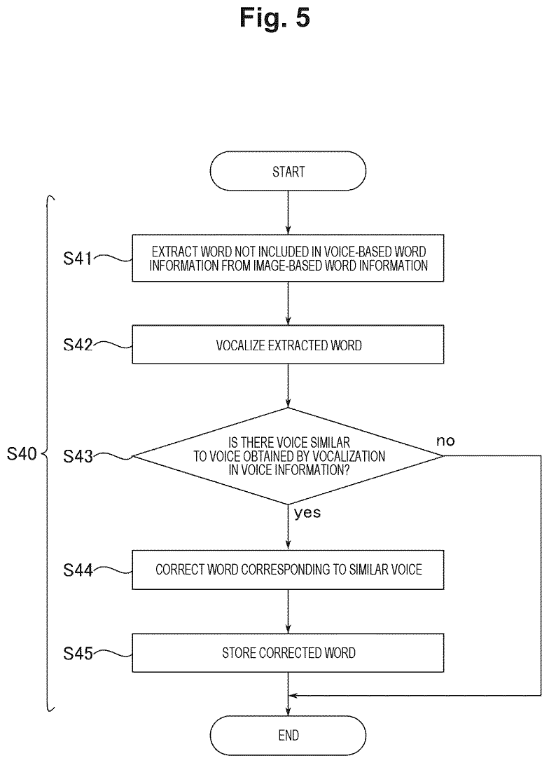

FIG. 5 is a flowchart illustrating an example of the correction operation for the voice-based word information in the information processing device according to the embodiment. The processing of S41, S42, S43, S44, and S45 illustrated in FIG. 5 is included in the processing of S40 illustrated in FIG. 4.

As illustrated in FIG. 5, in a case where there is a word included in the image-based word information WIa and not included in the voice-based word information WVa (start), the extraction unit 25 extracts a word not included in the voice-based word information WVa from the image-based word information WIa (S41). The extraction unit 25 transmits the extracted word to the vocalization unit 26 as the extracted image-based word information WIb.

The vocalization unit 26 vocalizes the word extracted in the processing of S41 (S42). The vocalization unit 26 transmits a voice obtained by the processing of S42 to the voice search unit 28 as the image-based voice information Vb.

The voice search unit 28 determines whether or not a voice (similar voice) similar to the voice obtained in the processing of S42 is in the voice information Va (S43).

In a case where there is no similar voice in the voice information Va (step S43; no), the correction operation for the voice-based word information ends (end).

In a case where there is a similar voice in the voice information Va (step S43; yes), the voice search unit 28 extracts a word corresponding to the similar voice from the voice-based word information WVa. The voice search unit 28 transmits the extracted word to the voice-based word information correction unit 30 as the correction target voice-based word information WVc.

The voice-based word information correction unit 30 corrects the word corresponding to the similar voice (S44). Specifically, the voice-based word information correction unit 30 causes the word in the correction target voice-based word information WVc to match the corresponding word in the extracted image-based word information WIb.

The voice-based word information correction unit 30 stores the corrected word in the storage 12 as the common word information W (S45).

When the processing of S45 ends, the correction operation for the voice-based word information ends (end).

### Specific Example A

Hereinafter, a specific example A of the correction operation for the voice-based word information will be described.

In the specific example A, the voice-based word information WVa includes six words of “HONJITSU”, “TENKI”, “SEITEN”, “SEIROU”, “HA”, and “TAKAI”. The image-based word information WIa includes six words of “HONJITSU”, “TENKI”, “SEITEN”, “SEIROU”, “ROU”, and “TAKASHI”.

In this case, the extraction unit 25 extracts two words of “ROU” and “TAKASHI” included in the image-based word information WIa and not included in the voice-based word information WVa, as the extracted image-based word information WIb. In addition, the extraction unit 25 stores four words “HONJITSU”, “TENKI”, “SEITEN”, and “SEIROU” common to the voice-based word information WVa and the image-based word information WIa in the storage 12 as the common word information W.

The vocalization unit 26 generates the image-based voice information Vb by vocalizing the two words OF “ROU” and “TAKASHI”.

The voice search unit 28 determines whether or not voices similar to “ROU” and “TAKASHI” are in the voice information Va. As described above, there are voices corresponding to “HA” and “TAKAI” in the voice information Va. For this reason, by focusing on a sound “TAKA” common to “TAKASHI” and “TAKAI”, the voice search unit 28 determines that a voice corresponding to “TAKASHI” is similar to a voice corresponding to “TAKAI” in the voice information Va. On the other hand, since there is no common sound between “ROU” and “HA”, the voice search unit 28 determines that a voice similar to a voice corresponding to “ROU” is not in the voice information Va. From the above, the voice search unit 28 extracts the word “TAKAI” similar to “TAKASHI” as the correction target voice-based word information WVc.

The voice-based word information correction unit 30 corrects “TAKAI” to “TAKASHI”. As a result, the voice-based word information correction unit 30 can further store the word “TAKASHI” in the storage 12 as the common word information W.

### 1.2.3 Details of Correction Operation for Image-Based Word Information

Next, a description will be given of details of the correction operation for the image-based word information in the information processing device according to the embodiment.

### (Flowchart)

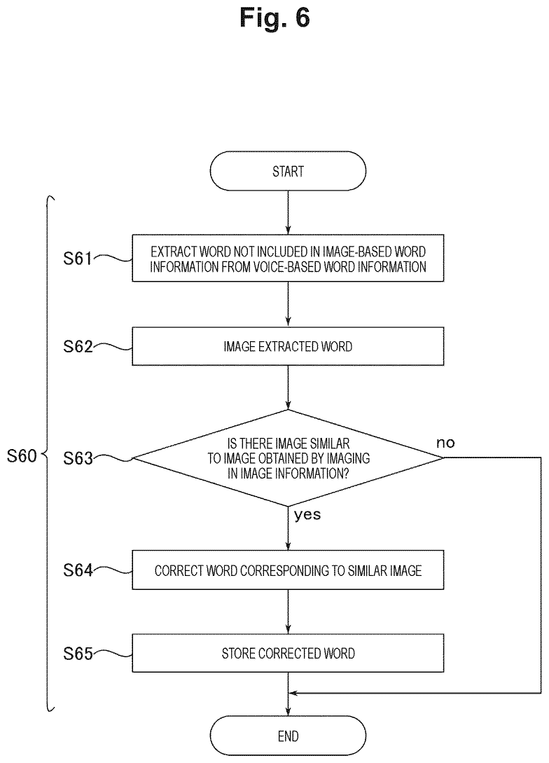

FIG. 6 is a flowchart illustrating an example of the correction operation for the image-based word information in the information processing device according to the embodiment. The processing of S61, S62, S63, S64, and S65 illustrated in FIG. 6 is included in the processing of S60 illustrated in FIG. 4.

As illustrated in FIG. 6, in a case where there is a word included in the voice-based word information WVa and not included in the image-based word information WIa (start), the extraction unit 25 extracts a word not included in the image-based word information WIa from the voice-based word information WVa (S61). The extraction unit 25 transmits the extracted word to the imaging unit 27 as the extracted voice-based word information WVb.

The imaging unit 27 images the word extracted in the processing of S61 (S62). The imaging unit 27 transmits an image obtained by the processing of S62 to the image search unit 29 as the voice-based image information Ib.

The image search unit 29 determines whether or not an image (similar image) similar to the image obtained in the processing of S62 is in the image information Ia (S63).

In a case where there is no similar image in the image information Ia (S63; no), the correction operation for the image-based word information ends (end).

In a case where there is the similar image in the image information Ia (S63; yes), the image search unit 29 extracts the word corresponding to the similar image from the image-based word information WIa. The image search unit 29 transmits the extracted word to the image-based word information correction unit 31 as the correction target image-based word information WIc.

The image-based word information correction unit 31 corrects the word corresponding to the similar image (S64). Specifically, the image-based word information correction unit 31 causes the word in the correction target image-based word information WIc to match the corresponding word in the extracted voice-based word information WVb.

The image-based word information correction unit 31 stores the corrected word in the storage 12 as the common word information W (S65).

When the processing of S65 ends, the correction operation for the image-based word information ends (end).

### Specific Example B

Hereinafter, a specific example B of the correction operation for the image-based word information will be described.

In the specific example B, the voice-based word information WVa includes six words of “SOUDAN”, “GIJUTSU”, “MATCHING”, “KEIREKI”, “HAIKEI”, and “CHISHIKI”. The image-based word information WIa includes six words of “SOUDAN”, “GIJUTSU”, “PAIRING”, “ZENSHOKU”, “HAIKEI”, and “YAKUCHISHIKI”.

In this case, the extraction unit 25 extracts three words of “MATCHING”, “KEIREKI”, and “CHISHIKI” included in the voice-based word information WVa and not included in the image-based word information WIa, as the extracted voice-based word information WVb. In addition, the extraction unit 25 stores three words of “SOUDAN”, “GIJUTSU”, and “HAIKEI” common to the voice-based word information WVa and the image-based word information WIa in the storage 12 as the common word information W.

The imaging unit 27 generates the voice-based image information Ib by imaging three words of “MATCHING”, “KEIREKI”, and “CHISHIKI”.

The image search unit 29 determines whether or not images similar to “MATCHING”, “KEIREKI”, and “CHISHIKI” are in the image information Ia. As described above, there are images corresponding to “PAIRING”, “ZENSHOKU”, and “YAKUCHISHIKI” in the image information Ia. For this reason, by focusing on similarity in shape between “YAKUCHISHIKI” and “CHISHIKI”, the image search unit 29 determines that an image corresponding to “CHISHIKI” is similar to an image corresponding to “YAKUCHISHIKI” in the image information Ia. On the other hand, since there is no image having a similar shape, the image search unit 29 determines that there are no images similar to images respectively corresponding to “MATCHING” and “KEIREKI” in the image information Ia. From the above, the image search unit 29 extracts the word “YAKUCHISHIKI” similar to “CHISHIKI” as the correction target image-based word information WIc.

The image-based word information correction unit 31 corrects “YAKUCHISHIKI” to “CHISHIKI”. As a result, the image-based word information correction unit 31 can further store the word “CHISHIKI” in the storage 12 as the common word information W.

### 1.2.4 Scope of Application Range

Next, an application range of complementary correction operation according to the present embodiment will be described.

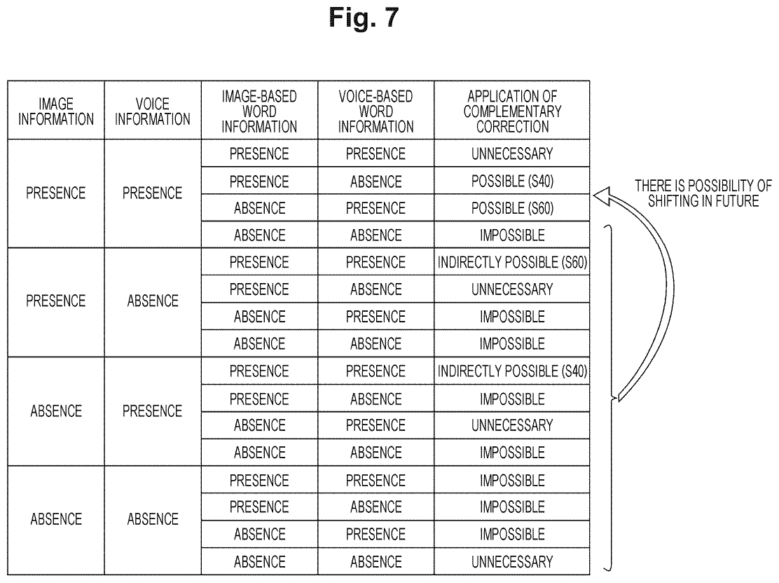

FIG. 7 is a diagram illustrating an application range of the correction operation in the information processing device according to the embodiment. In FIG. 7, 16 patterns are illustrated depending on whether or not words recognized from the image information Ia and the voice information Va are respectively included in the image-based word information WIa and the voice-based word information WVa.

As illustrated in FIG. 7, in a case where the presence or absence of a word in the image information Ia matches the presence or absence of the word in the image-based word information WIa and the presence or absence of a word in the voice information Va matches the presence or absence of the word in the voice-based word information WVa, the correction operation is unnecessary. That is, the complementary correction operation according to the present embodiment is unnecessary for 4 patterns among the 16 patterns.

In a case where a word recognized from the image information Ia matches a word included in the image-based word information WIa but a word recognized from the voice information Va is not included in the voice-based word information WVa, the correction operation for the voice-based word information according to the present embodiment can be applied. Accordingly, it is possible to indirectly resolve a case where a word recognized from the image information Ia matches a word included in the image-based word information WIa but a word not recognized from the voice information Va is included in the voice-based word information WVa. In addition, in a case where a word recognized from the voice information Va matches a word included in the voice-based word information WVa but a word recognized from the image information Ia is not included in the image-based word information WIa, the correction operation for the image-based word information according to the present embodiment can be applied. Accordingly, it is possible to indirectly resolve a case where a word recognized from the voice information Va matches a word included in the voice-based word information WVa but a word not recognized from the image information Ia is included in the image-based word information WIa. That is, the complementary correction operation according to the present embodiment can be applied to 4 patterns among the 16 patterns.

Remaining eight patterns are a pattern having a low possibility of occurrence and a pattern that cannot be corrected, and thus are out of the application range of the complementary correction operation according to the present embodiment. However, there is a possibility that these eight patterns shift to patterns to which the above-described complementary correction operation can be applied by improving recognition accuracy of the image recognition processing and the voice recognition processing alone. For this reason, these eight patterns can be said to be potential application targets of the complementary correction operation according to the present embodiment.

As described above, it can be seen that the complementary correction operation according to the present embodiment widely contributes to improvement of accuracy of word recognition from the image information Ia and the voice information Va.

### 1.3 Effects According to Embodiment

According to the embodiment, the image recognition unit 24 recognizes the image-based word information WIa from the image information Ia. The voice recognition unit 23 recognizes the voice-based word information WVa from the voice information Va. The extraction unit 25 extracts a word included in the voice-based word information WVa based on the voice information Va and not included in the image-based word information WIa based on the image information Ia, as the extracted voice-based word information WVb. The extraction unit 25 extracts a word included in the image-based word information WIa based on the image information Ia and not included in the voice-based word information WVa based on the voice information Va, as the extracted image-based word information WIb. The image-based word information correction unit 31 performs correction to cause the correction target image-based word information WIc corresponding to the extracted voice-based word information WVb in the image-based word information WIa to match the extracted voice-based word information WVb. The voice-based word information correction unit 30 performs correction to cause the correction target voice-based word information WVc corresponding to the extracted image-based word information WIb in the voice-based word information WVa to match the extracted image-based word information WIb. As a result, a result of character recognition from the image information Ia and a result of character recognition from the voice information Va can be complementarily complemented. For this reason, a rate of recognition of the common word information W can be improved.

Specifically, the imaging unit 27 converts the extracted voice-based word information WVb into the voice-based image information Ib. The image search unit 29 searches the image information Ia for a similar image of the voice-based image information Ib. As a result, a word erroneously recognized in the image recognition processing can be corrected by comparison with an image converted on the basis of the voice information Va. Describing along the specific example B, a word erroneously recognized as “YAKUCHISHIKI” in the image recognition processing can be corrected to a correct word of “CHISHIKI” by comparison with the image converted on the basis of the voice information Va. For this reason, the accuracy of word recognition based on the image can be improved by using the voice.

In addition, the image search unit 29 calculates a feature value of each of the image information Ia and the voice-based image information Ib. The image search unit 29 extracts a portion of the image information Ia having a feature value whose similarity with the voice-based image information Ib is greater than or equal to a threshold as the correction target image-based word information WIc. As a result, it is possible to extract a set of words similar to each other as images, such as “YAKUCHISHIKI” in the image-based word information WIa and “CHISHIKI” in the voice-based image information Ib, as correction possibilities.

In addition, the vocalization unit 26 converts the extracted voice-based word information WVb into the voice-based image information Ib. The voice search unit 28 searches the voice information Va for a similar voice of the image-based voice information Vb. As a result, a word erroneously recognized in the voice recognition processing can be corrected by comparison with a voice converted on the basis of the image information Ia. Describing along the specific example A, the word “TAKAI” in the voice recognition processing can be corrected to the word “TAKASHI” by comparison with the voice converted on the basis of the image information Ia. For this reason, the accuracy of word recognition based on the voice can be improved by using the image.

In addition, the voice search unit 28 calculates a feature value of each of the voice information Va and the image-based voice information Vb. The voice search unit 28 extracts a portion of the voice information Va having a feature value whose similarity with the image-based voice information Vb is greater than or equal to a threshold as the correction target voice-based word information WVc. As a result, a set of words similar to each other as voices, such as “TAKAI” in the voice-based word information WVa and “TAKASHI” in the image-based voice information Vb, can be extracted as correction possibilities.

In addition, the information processing device 100 uses the image-based word information WIa and the voice-based word information WVa independently of each other with respect to time. As a result, the accuracy of word recognition can be improved without requiring simultaneous input of the voice information Va and the image information Ia.

### 2. Others

Note that various modifications can be applied to the above-described embodiments.

For example, in the above-described embodiments, a case has been described where a program for executing the correction operation is executed by the information processing device 100 in the information processing system 1, but the present invention is not limited thereto. For example, the program for executing the correction operation may be executed by a calculation resource on a cloud.

Note that the present invention is not limited to the embodiments described above, and various modifications can be made in the implementation stage without departing from the scope of the invention. In addition, the embodiments may be implemented in appropriate combination, and in that case, combined effects can be obtained. Furthermore, the embodiments described above include various inventions, and various inventions can be extracted by a combination selected from a plurality of disclosed components. For example, even if some components are deleted from all the components described in the embodiments, in a case where the problem can be solved and the effects can be obtained, a configuration from which the components are deleted can be extracted as an invention.

### REFERENCE SIGNS LIST

1 Information processing system
11 Control circuit
12 Storage
13 Communication module
14 Drive
15 Storage medium
21 Voice reception unit
22 Image reception unit
23 Voice recognition unit
24 Image recognition unit
25 Extraction unit
26 Vocalization unit
27 Imaging unit
28 Voice search unit
29 Image search unit
30 Voice-based word information correction unit
31 Image-based word information correction unit
100 Information processing device
200, 300 Terminal

1. An information processing device comprising:
voice recognition circuitry that recognizes a plurality of first words on a basis of a first voice:
image recognition circuitry that recognizes a plurality of second words on a basis of a first image:
extraction circuitry that extracts at least one of a third word included in the plurality of first words and not included in the plurality of second words or a fourth word included in the plurality of second words and not included in the plurality of first words;
first correction circuitry that corrects a fifth word corresponding to the third word among the plurality of second words to the third word; and
second correction circuitry that corrects a sixth word corresponding to the fourth word among the plurality of first words to the fourth word.

2. The information processing device according to claim 1, further comprising:
first conversion circuitry that converts the third word into a second image; and
first search circuitry that searches the first image for a third image similar to the second image and searches the plurality of second words for a word corresponding to the third image as the fifth word.

3. The information processing device according to claim 2, wherein the first search circuitry:
calculates a feature value of each of the first image and the second image, and
extracts, as the third image, a portion of the first image having a feature value whose similarity with the second image is greater than or equal to a threshold.

4. The information processing device according to claim 1, further comprising:
second conversion circuitry that converts the fourth word into a second voice; and
second search circuitry that searches the first voice for a third voice similar to the second voice and searches the plurality of first words for a word corresponding to the third voice as the sixth word.

5. The information processing device according to claim 4, wherein the second search circuitry;
calculates a feature value of each of the first voice and the second voice, and
extracts, as the third voice, a portion of the first voice having a feature value whose similarity with the second voice is greater than or equal to a threshold.

6. The information processing device according to claim 1, wherein:
the plurality of first words and the plurality of second words are independent of each other with respect to time.

7. An information processing method comprising:
recognizing a plurality of first words on a basis of a first voice;
recognizing a plurality of second words on a basis of a first image;
extracting at least one of a third word included in the plurality of first words and not included in the plurality of second words or a fourth word included in the plurality of second words and not included in the plurality of first words;
correcting a fifth word corresponding to the third word among the plurality of second words to the third word; and
correcting a sixth word corresponding to the fourth word among the plurality of first words to the fourth word.

8. A non-transitory computer readable medium storing a program causing a computer to function as each circuitry included in the information processing device according to claim 1.

9. A non-transitory computer readable medium storing a program, which when executed, causes a computer to perform the method of claim 7.
